(19) United States
(12) Patent Application Publication
(10) Pub. No.: US 2023/0327252 A1
(43) Pub. Date: Oct. 12, 2023

(54) BATTERY MODULE

(71) Applicant: HONDA MOTOR CO., LTD., Tokyo (JP)

(72) Inventors: Takahiro YASUE, Saitama (JP); Hidemasa USUI, Saitama (JP); Takahiro TAMURA, Saitama (JP); Junya FUNATSU, Saitama (JP); Takashi MATSUO, Saitama (JP); Nobuhiko YOSHIMOTO, Saitama (JP); Jun TAKAI, Saitama (JP); Toru EGUCHI, Saitama (JP)

(21) Appl. No.: 18/192,671

(22) Filed: Mar. 30, 2023

(30) Foreign Application Priority Data
Mar. 31, 2022 (JP) 2022-061374
Mar. 28, 2023 (JP) 2023-052222

(51) Int. Cl. H01M 50/209; H01M 50/242; H01M 10/653

(52) U.S. Cl. CPC H01M 50/209; H01M 10/653; H01M 50/242

(57) ABSTRACT

An object is to provide a battery module with higher energy density. A battery module includes a plurality of battery cells each including a layered body and an exterior body, in which
a first periphery of each of any general battery cells arranged in a layered direction of the layered bodies includes a first bend that is coupled to a first bottom surface formed on a circumference of the exterior body and that bends toward one side in the layered direction, and
a first extension extending from the first bend toward the one side in the layered direction, and
the first extension includes
   a first region extending from the first bend to another end in the layered direction of the next battery cell, and
   a second region extending from the other end in the layered direction of the next battery cell toward the one side in the layered direction.

This application is based on and claims the benefit of priority from Japanese Patent Application Nos. 2022-061374 and 2023-052222, respectively filed on 31 Mar. 2022 and 28 Mar. 2023, the contents of which are incorporated herein by reference.

### BACKGROUND OF THE INVENTION

### Field of the Invention

The present invention relates to a battery module.

### Related Art

Conventionally, such technologies have been known that make storage batteries lighter in weight and smaller in size. Japanese Unexamined Patent Application, Publication No. 2015-225765 describes one example of such kind of technology. Japanese Unexamined Patent Application, Publication No. 2015-225765 describes a cooling structure for storage battery modules, which includes a heat sink that cools a group of storage batteries, and a partition member that is disposed between the group of storage batteries and the heat sink and that has a plurality of compartment regions divided for each of the storage batteries.

Patent Document 1: Japanese Unexamined Patent Application, Publication No. 2015-225765

### SUMMARY OF THE INVENTION

By the way, such a battery module (an electricity storage module) as described in Japanese Unexamined Patent Application, Publication No. 2015-225765 includes, in addition to the plurality of battery cells (the group of storage batteries), other components that do not store electricity such as a component that cools battery cells (the heat sink). There is thus a need for improvements in terms of energy density since there is a need to reduce such components that do not store electricity.

An object of the present invention is to provide a battery module with higher energy density.

(1) A battery module includes a plurality of battery cells (for example, battery cells 10 described later) each including a layered body (for example, a layered body 10b described later) layered with a positive electrode layer, a solid electrolyte layer or a separator, and a negative electrode layer, and
an exterior body (for example, an exterior body 10a described later) wrapping around the layered body, in which the plurality of battery cells are arranged in a layered direction of the layered bodies, and,
when any one of the battery cells excluding the battery cell on an end side among the plurality of battery cells is designated as a first battery cell (for example, a general battery cell 10A described later),
the exterior body of the first battery cell includes
   a first housing (for example, a first housing 11A described later) accommodating the layered body, and
   a first periphery (for example, a first periphery 12A described later) formed around the entire circumference of the first housing,
the first periphery includes
   a first bend (for example, a first bend 12A a described later) that is coupled to one surface (for example, a first bottom surface 11Ab described later) formed on the circumference of the first housing and that has a shape bending toward one side in the layered direction, and
   a first extension (for example, a first extension 12Ab described later) extending from the first bend toward the one side in the layered direction, and
the first extension includes
   a first region (for example, a first region 12Ab1 described later) extending from the first bend to another end in the layered direction of a second battery cell next to the first battery cell (for example, a next battery cell 10 described later), and
   a second region (for example, a second region 12Ab2 described later) extending from the other end in the layered direction of the second battery cell toward the one side in the layered direction.

(2) The battery module described in (1) further includes a thermal conductor (for example, a thermal conductor 50 described later) disposed at a position opposed to the first housing to sandwich the first extension of the first periphery between the thermal conductor and the first housing.

(3) The battery module described in (2) further includes a temperature adjuster (for example, a water jacket 70 described later) that is disposed at a position opposed to the first extension so that the thermal conductor is provided between the temperature adjuster and the first extension, and that is able to adjust a temperature inside the battery module via the thermal conductor.

(4) The battery module described in (3) further includes: a plurality of cushions alternately arranged with the plurality of battery cells (for example, cushions 20 described later) in a layered direction; two end plates (for example, end plates 30 described later) disposed to sandwich both end sides in the layered direction of the arrangement of the battery cells and the cushions; and two bind bars (for example, bind bars 40 described later) disposed to sandwich
the arrangement of the battery cells and the cushions in an upper-lower or lower-upper direction orthogonal or substantially orthogonal to the layered direction, in which the thermal conductor includes a plurality of thermal conductive gel, and
the temperature adjuster is disposed to be in contact with the thermal conductive gels to sandwich the thermal conductive gel, the bind bars, and the thermal conductive gel in order between the temperature adjuster and the first extension.

(5) The battery module described in any one of (2) to (4), in which, when the second battery cell is the battery cell (for example, an end battery cell 10B described later) at an end in an arrangement of the plurality of battery cells on one side in the layered direction, the thermal conductor is not disposed in an area on the one side in the layered direction of the second battery cell in the layered direction.

(6) The battery module described in any one of (1) to (5), in which, in the first region of the first extension, a highly viscous fluid (for example, grease 60 described later) is provided between the one surface and the first periphery.

(7) The battery module described in any one of (1) to (6), in which, when the second battery cell is the battery cell at the end in the arrangement of the plurality of battery cells,
the exterior body of the second battery cell includes
   a second housing (for example, a second housing 11B described later) accommodating the layered body, and
   a second periphery (for example, a second periphery 12B described later) formed around the entire circumference of the second housing, and
the second periphery includes
   a second bend (for example, a second bend 12Ba described later) having a bent shape coupled to the circumference of the second housing,
   a second extension (for example, a second extension 12Bb described later) extending from the second bend toward the one side in the layered direction,
   a third bend (for example, a third bend 12Bc described later) that is coupled to one end of the second extension and that has a shape bending toward the second housing, and
   a third extension (for example, a third extension 12Bd described later) extending from the third bend toward the other side in the layered direction.

(8) The battery module described in (5), in which, when the second battery cell is the battery cell at the end in the arrangement of the plurality of battery cells,
the exterior body of the second battery cell includes
   a second housing (for example, a second housing 11B1 described later) accommodating the layered body, and
   a second periphery (for example, a second periphery 12B1 described later) formed on a circumference of the second housing, and
the second periphery includes
   a second bend (for example, a second bend 12Ba1 described later) having a bent shape coupled to the circumference of the second housing,
   a second extension (for example, a second extension 12Bb1 described later) extending from the second bend toward the one side in the layered direction,
   a third bend (for example, a third bend 12Bc1 described later) that is coupled to one end of the second extension and that has a shape bending away from the second housing, and
   a third extension (for example, a third extension 12Bd1 described later) extending from the third bend toward the other side in the layered direction.

(9) The battery module described in any one of (1) to (8), in which the first periphery includes
an upper surface side first bend (for example, an upper surface side first bend 12Ca described later) having a bent shape and being coupled to another surface than the one surface (for example, a first upper surface 11Ac described later) of the first housing, and
an upper surface side first extension (for example, an upper surface side first extension 12Cb described later) extending from the upper surface side first bend toward the one side in the layered direction.

(10) The battery module described in any one of (1) to (9), in which an insulation sheet is provided between the first extension and the one surface formed at the circumference of the first housing of any of the battery cells excluding the battery cell at an end side among the plurality of battery cells, and between the first extension and the one surface formed at the circumference of the housing of the battery cell adjacent to this battery cell.

(11) The battery module as described in (10), further including a thermal conductor disposed at a position opposing the first housing so as to sandwich the first extension of the first periphery, the insulation sheet extends more to the one side than a tip of the layered direction of the first extension of any of the battery cells excluding the battery cell at an end side among the plurality of the battery cells, and is disposed between the thermal conductor and the first extension of the battery cell adjacent to this battery cell.

(12) The battery module as described in (10) or (11), in which the insulation sheet is adhered to the first extension.

(13) The battery module as described in any one of (10) to (12), in which grease is filled between the insulation sheet and the first extension.

According to the present invention, it is possible to provide a battery module with higher energy density.

### BRIEF DESCRIPTION OF THE DRAWINGS

FIG. 1 is a schematic cross-sectional view illustrating an example cross section when a battery module according to an embodiment of the present invention is cut in a layered direction, where

it should be noted that, in the view, general battery cells and an end battery cell are not illustrated in cross sections, but illustrated in external views;

FIG. 2 is a schematic view illustrating an example exterior body before a layered body according to the embodiment of the present invention is disposed;

FIG. 3 is a schematic view illustrating the example exterior body when the layered body according to the embodiment of the present invention is disposed and the exterior body is folded;

FIG. 4 is a schematic view illustrating the example exterior body after the layered body according to the embodiment of the present invention is disposed and the exterior body is folded and sealed;

FIG. 5 is a schematic cross-sectional view illustrating a cross section of an area around a first periphery of the general battery cell disposed at an intermediate position, according to the embodiment of the present invention, where it should be noted that, in the view, the general battery cells are not illustrated in cross sections, but are illustrated in external views;

FIG. 6 is a schematic cross-sectional view illustrating a cross section of an area around a second periphery of the end battery cell disposed at an end, according to the embodiment of the present invention, where it should be noted that, in the view, the end battery cell is not illustrated in a cross section, but is illustrated in an external view;

FIG. 7 is a schematic cross-sectional view illustrating a cross section of an area around a second periphery of an end battery cell disposed at an end, according to a first modification example of the present invention, where it should be noted that, in the view, the end battery cell is not illustrated in a cross section, but is illustrated in an external view;

FIG. 8 is a schematic cross-sectional view illustrating a cross section of an area around a second periphery of an end battery cell disposed at an end, according to a second modification example of the present invention, where it should be noted that, in the view, the end battery cell is not illustrated in a cross section, but is illustrated in an external view;

FIG. 9 is a schematic cross-sectional view illustrating a cross section of an area around an upper surface side first periphery of a general battery cell disposed at an intermediate position, according to a third modification example of the present invention, where it should be noted that, in the view, the general battery cells are not illustrated in cross sections, but are illustrated in external views;

FIG. 10 is a schematic cross-sectional view showing an example of a cross section in the case of cutting the battery module according to a fourth modification example of the present invention in the layered direction.

It should be noted that the general battery cell and end battery cell in the drawing are not cross sections, but rather shown in an external appearance view;
FIG. 11 is a schematic view showing an example of battery cells in a state in which the layered body of the fourth modification example of the present invention is arranged, and an insulation sheet is pasted to the exterior body after being folded back and sealed;
FIG. 12 is a partial enlarged cross-sectional view enlarging a cross section of part of the first periphery of the general battery cell arranged at an intermediate position according to the fourth modification example of the present invention.

It should be noted that the general battery cell in the drawing is not a cross section, but rather is shown in an external appearance view.

In addition, configurations not used in the description are partly omitted from illustration for convenience of explanation;
FIG. 13 is a schematic view when viewing, from a lateral side, a battery cell according to the fourth modification example of the present invention after pasting the insulation sheet to the periphery;
FIG. 14 is a schematic view when viewing, from a lateral side, the battery cell in which the periphery of the battery cell in FIG. 13 was bent; and
FIG. 15 is a schematic view showing an aspect of assembling the battery cell of FIG. 14 to the battery module.

### DETAILED DESCRIPTION OF THE INVENTION

### Battery Module

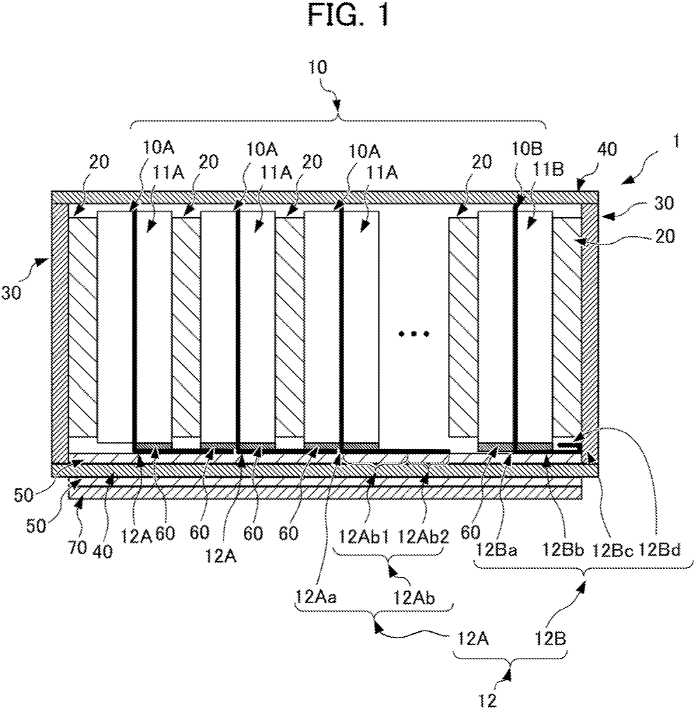

An example of a battery module 1 according to an embodiment of the present invention will now be described with reference to FIGS. 1 to 4. FIG. 1 is a schematic cross-sectional view illustrating a cross section when the battery module 1 is cut in a layered direction. The layered direction refers to a direction in which a positive electrode layer and other layers are layered in a layered body 10b of a battery cell 10 described later, and refer to a left-right or right-left direction in FIG. 1.

The battery module 1 according to the present embodiment is mounted, for example, on an electric vehicle (EV) for supplying electrical power. The battery module 1 includes a plurality of the battery cells 10, a plurality of cushions 20, two end plates 30, two bind bars 40, a thermal conductor 50, grease 60 serving as a highly viscous fluid applied at a plurality of locations, and a water jacket 70 serving as a temperature adjuster.

The end plates 30 are components for securing the plurality of battery cells 10 and other components in the layered direction. The bind bars 40 are components for securing the plurality of battery cells 10 and other components. In the battery module 1 according to the present embodiment, the plurality of battery cells 10 and the cushions 20 are alternately arranged in the layered direction to dispose two of the cushions 20 on both end sides. Furthermore, the two end plates 30 are disposed to sandwich both the end sides of the arrangement, in the layered direction, of the battery cells 10 and the cushions 20. Furthermore, the two bind bars 40 are disposed to sandwich the arrangement of the battery cells 10 and the cushions 20 in an upper-lower or lower-upper direction in FIG. 1, which is orthogonal to the arrangement direction (the layered direction).

The thermal conductor 50 is a component that releases heat generated inside the layered bodies 10b to outside via the water jacket 70 described later. The thermal conductor 50 is, for example, a thermal conductive gel provided between the battery cell 10 and the bind bar 40. More specifically, the thermal conductive 50 is a thermal conductive gel provided between the first extension 12Ab of the battery cell 10 and the bind bar 40. Furthermore, it is desirable that a component that is substantially equivalent to the thermal conducive gel of the thermal conductor 50 be provided for the purpose of improving the thermal conductivity between the bind bar 40 and a water jacket 70 described later. For this reason, in the battery module 1 according to the present embodiment, a thermal conductive gel of the thermal conductor 50 may be further provided between the bind bar 40 and the water jacket 70. In other words, the thermal conductor 50 according to the present embodiment includes a plurality of thermal conductive gels. It should be noted that the configuration in which the thermal conductive gel being provided or interposed between the bind bar 40 and the water jacket 70 and the configuration in which the bind bar 40 and the water jacket 70 sandwich the thermal conductive gel may indicate that they are in contact with one another or are in non-contact with one another. As the thermal conductor 50, a heat transmitting gel, i.e., a thermal conductive gel such as a silicone gel may be used. Furthermore, for example, as the thermal conductor 50, a urethane-based, epoxy-based, modified-silane-based, or acrylic-based heat-radiating adhesive may be used. Furthermore, for example, as the thermal conductor 50, a sheet of clay-like putty made of silicone with heat-radiating properties or silicone grease with heat-radiating properties, which closely adheres to an uneven surface, may be used.

The grease 60 is a highly viscous fluid that is able to transmit heat from the battery cells 10 to the thermal conductor 50, that fills spaces between peripheries 12 that are bent, described later, and the battery cells 10 and spaces between the peripheries 12 that are bent and the thermal conductor 50, and that prevents air from entering and being trapped, for example. The grease 60 is applied onto a bottom surface of the battery cell 10 before the periphery 12 is bent. Note that it is possible to adopt mineral oil, silicone, or other materials as a base oil component of the grease 60. When adopting grease as a highly viscous fluid, one rated with NLGI No. 1 or greater (and 6 or smaller), according to ASTM D217 (JIS K2220), is preferable in terms of suppressing pumping-out. Furthermore, as a highly viscous fluid, it is not limited to the grease 60, but it is possible to adopt those with thermal conduction effects, excluding those that fully lock folded sections such as adhesives.

The water jacket 70 is a component that releases heat generated inside and that warms up the battery module 1. The water jacket 70 is disposed under the battery cells 10 so that the thermal conductor 50 is provided between the water jacket 70 and the first extension 12Ab, as illustrated in FIG. 1. More specifically, the water jacket 70 is disposed to be in contact with the thermal conductive gels of the thermal conductor 50 to sandwich the thermal conductive gel of the thermal conductor 50, the bind bars, and the thermal conductive gel of the thermal conductor 50 in order between the water jacket 70 and the first extension 12Ab. Note that, in the example in FIG. 1, the size of the water jacket 70 in the layered direction and the depth direction of FIG. 1 is substantially the same as the space in which the battery cells 10 are arranged, but the present invention is not limited thereto, and also note the battery module 1 according to the present embodiment includes the water jacket 70 as a temperature adjuster for adjusting the temperature inside the battery module 1, but the present invention is not limited to include such a temperature adjuster. For example, the battery module 1 may include, instead of the water jacket 70, a heat sink serving as a cooler for releasing, in an air-cooling manner, heat generated inside the battery module 1.

### Battery Cell

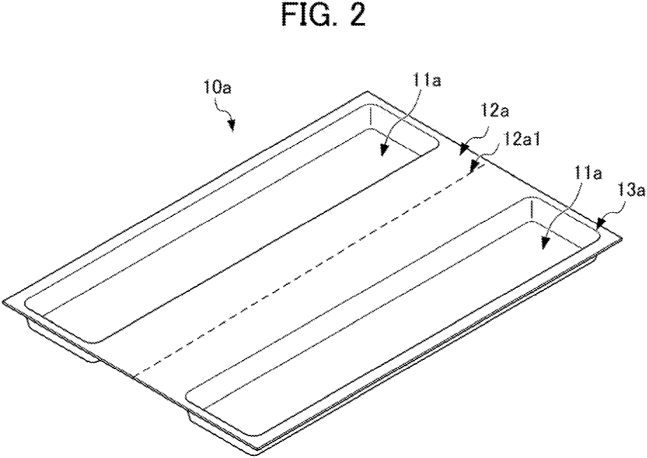

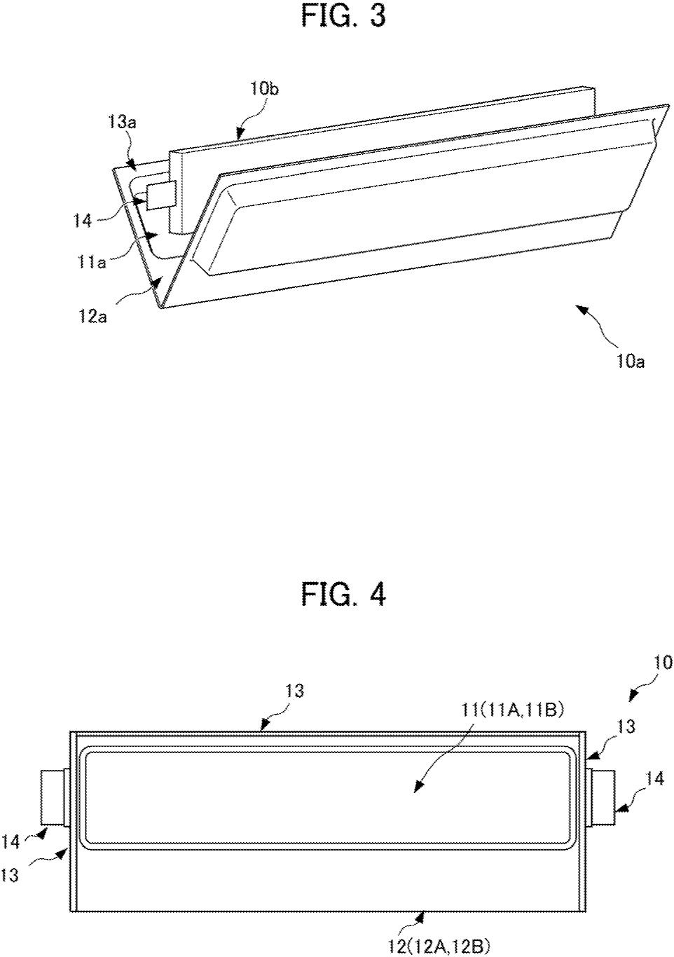

Next, the battery cell 10 will now be described with reference to FIGS. 2 to 4. FIG. 2 illustrates an exterior body 10a after recesses 11a are formed at two locations on a sheet member. FIG. 3 illustrates a state where the exterior body 10a in the state illustrated in FIG. 2 is set with the layered body 10b and is folded at a folding part 12a.

In the battery cell 10 illustrated in FIG. 4, the illustrated is the battery cell 10 after the exterior body 10a in the state illustrated in FIG. 3 is folded and a sealing surface 13a is sealed to form a seal 13.

The battery cell 10 according to the present embodiment is a component for storing electricity in the battery module 1. The battery cell 10 is a storage battery, and an electrolyte used may be in the form of liquid or solid. The plurality of battery cells 10 that the battery module 1 contains include, among the plurality of battery cells 10 included in the battery module 1, an end battery cell 10B disposed at one end in the layered direction, and general battery cells 10A disposed at other locations than at the one end in the layered direction.

The end battery cell 10B is the battery cell 10 disposed at a right end position in the arrangement of the plurality of battery cells 10 in FIG. 1. Furthermore, the general battery cells 10A are all the battery cells 10 disposed from a left end position in the arrangement of the plurality of battery cells 10 to a position next to a left side of the end battery cell 10B. Note that the general battery cells 10A and the end battery cell 10B differ from each other in the shape of the periphery 12, described later, but are identical to each other in other configurations than the shape of the periphery 12.

The battery cell 10 is formed by wrapping around the layered body 10b with the exterior body 10a illustrated in FIGS. 2 and 3. Furthermore, the exterior body 10a of the battery cell 10 includes, as illustrated in FIGS. 1 and 4, a housing 11 accommodating the layered body 10b, and the periphery 12 formed around the entire circumference of the housing 11. The layered body 10b is constructed by layering a positive electrode layer made of nickel, cobalt, manganese, or other material, a solid electrolyte layer or a separator, and a negative electrode layer made of a Li metal, Si, or other material. The layered body 10b includes two electrodes 14 respectively coupled to the positive electrode layer and the negative electrode layer, as illustrated in FIGS. 3 and 4. It should be noted that the electrode 14 is omitted from illustration in drawings other than FIGS. 3 and 4 for convenience of explanation.

The exterior body 10a according to the present embodiment is formed from a sheet member. The exterior body 10a is formed with the recesses 11a that are able to accommodate the layered body 10b at the two locations on the sheet member, as illustrated in FIG. 2, folded at the folding part 12a to wrap around the layered body 10b with the recesses at the two locations, as illustrated in FIG. 3, and formed with the seal 13 sealing the sealing surface 13a on the three sides, as illustrated in FIG. 4. Furthermore, as will be described later, the battery cell 10 after being sealed is assembled into the battery module 1 after the periphery 12 is further bent.

Note that the recesses 11a, the folding part 12a, and the sealing surface 13a of the exterior body 10a will be described below as configurations before the three sides of the exterior body 10a are sealed, and the housing 11, the periphery 12, and the seal 13 of the battery cell 10 will be described below as configurations after the three sides of the exterior body 10a are sealed.

The exterior body 10a is formed with, as illustrated in FIG. 2, the recesses 11a at the two locations, the folding part 12a representing a plane between the recesses 11a at the two locations, and the sealing surface 13a surrounding the recesses 11a at the two locations and the folding part 12a.

The recesses 11a at the two locations are configured to accommodate the layered body 10b. The recesses 11a at the two locations each form a space having a substantially rectangular parallelepiped shape that is able to cover half of the layered body 10b. As to the space formed in each of the recesses 11a, the shape of the space is substantially similar to the shape of the layered body 10b when cut into halves in the layered direction, and it is formed greater than the shape of the layered body 10b. Furthermore, the two recesses 11a are formed so that they are substantially line symmetrical with respect to an intermediate line 12a1 of the folding part 12a, described later.

The folding part 12a represents a plane between the two recesses 11a for folding the exterior body 10a. In the present embodiment, the folding part 12a is folded along the intermediate line 12a1 at a substantially intermediate position between the two recesses 11a.

The exterior body 10a before folding is formed with the spaces that are able to wholly cover the layered body 10b inside the exterior body 10a by folding it along the intermediate line 12a1 of the folding part 12a as illustrated in FIG. 3 and by allowing the two recesses 11a described above to face each other.

Furthermore, the folding part 12a configures, after being folded along the intermediate line 12a1 of the folding part 12a, the periphery 12 together with the seal 13 formed through sealing. Furthermore, the folding part 12a according to the present embodiment is further bent before assembling into the battery module 1, as will be described later, and disposed, as a spacer, between the housing 11 and the thermal conductor 50.

Therefore, the width of the folding part 12a in a direction of sandwiching between the two recesses 11a is set to a length so as to extend to a space between the housing 11 of the next battery cell 10 on the one side in the layered direction and the thermal conductor 50. For example, the width of the folding part 12a is set to twice of a sum of the thickness of the single battery cell 10 in the layered direction and the thickness of the single cushion 20 in the layered direction. However, the width of the folding part 12a is not limited to this setting.

The sealing surface 13a is a part that undergoes a sealing treatment performed on, among the four sides of the exterior body 10a after being folded, the three sides where the folding part 12a is not present. The sealing surface 13a comes into contact, when the exterior body 10a is folded along the folding part 12a, with the sealing surface 13a itself, the part of which is present at the symmetry position with respect to the intermediate line 12a1 of the folding part 12a, and is then heated in a state of being in contact with the sealing surface 13a itself, the part of which is present at the symmetry position, for sealing to form the seal 13 illustrated in FIG. 4. Furthermore, the sealing surface 13a is sealed together with the sealing surface 13a itself, the part of which is present at the symmetry position, to configure the periphery 12 together with the folding part 12a, described later. Furthermore, the housing 11 is able to accommodate in a sealed manner the layered body 10b from outside when the sealing surface 13a is sealed.

### Periphery of General Battery Cell

Next, the configuration of a first periphery 12A in the battery module 1 according to the present embodiment will now be described herein. In the present embodiment, as described above, a second periphery 12B of the end battery cell 10B and the first periphery 12A of the general battery cell 10A, among the peripheries 12 of the battery cells 10 in the battery module 1, differ from each other in shape.

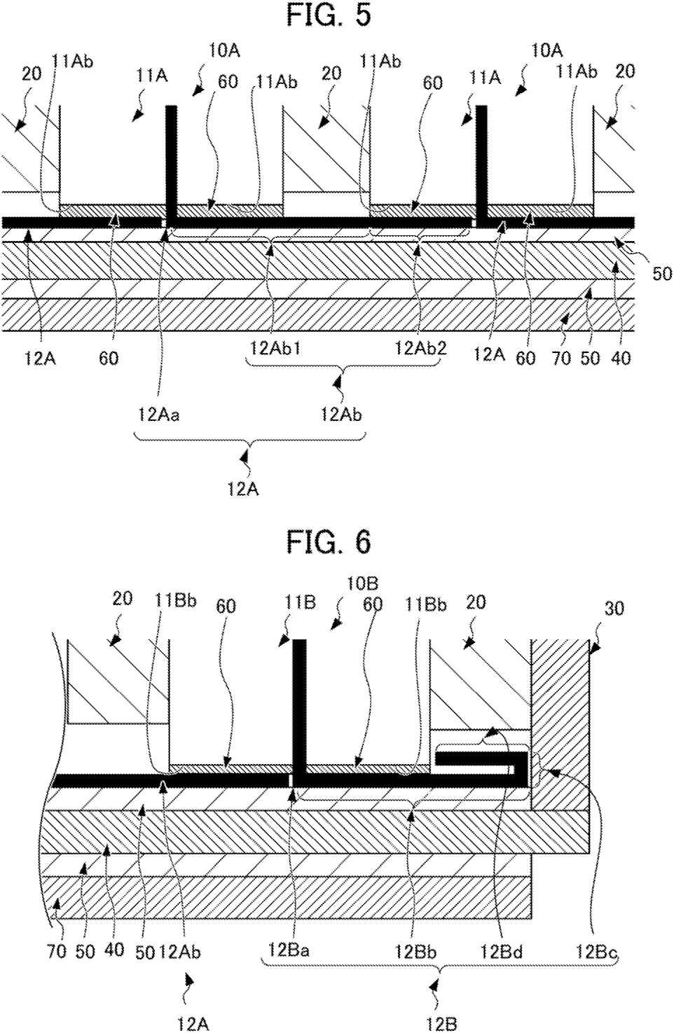

The shape of the first periphery 12A of the general battery cell 10A will now first be described with reference to FIG. 5. FIG. 5 is a schematic cross-sectional view illustrating a cross section of an area around the first periphery 12A of the general battery cell 10A disposed at an intermediate position, according to the embodiment of the present invention.

The first periphery 12A includes, as illustrated in FIG. 5, a first bend 12A a having a bent shape coupled to a first bottom surface 11Ab that is one surface formed on a circumference of a first housing 11A that is the housing 11 in the general battery cell 10A, and a first extension 12Ab extending from the first bend 12A a toward one side in the layered direction.

The first extension 12Ab includes
a first region 12Ab1 extending from the first bend 12A a to another end in the layered direction of the next battery cell 10, and
a second region 12Ab2 extending from the other end in the layered direction of the next battery cell 10 toward the one side in the layered direction. The first region 12Ab1 is a part, on the first extension 12Ab, for positioning between the general battery cell 10A serving as a first battery cell and the thermal conductor 50. The second region 12Ab2 is a part, on the first extension 12Ab, for positioning between the next battery cell 10 serving as a second battery cell and the thermal conductor 50.

In the battery cell 10 according to the present embodiment, as illustrated in FIG. 4, after the sealing surface 13a is sealed and the seal 13 is formed, and then the grease 60 is applied onto the first bottom surface 11Ab of the first housing 11A, the first periphery 12A is bent at its base toward the one side in the layered direction and the first bend 12A a is thus formed.

### Periphery of End Battery Cell

Next, the shape of the second periphery 12B of the end battery cell 10B will now be described with reference to FIG. 6. FIG. 6 is a schematic cross-sectional view illustrating a cross section of an area around the second periphery 12B of the end battery cell 10B disposed at the end, according to the embodiment of the present invention.

The second periphery 12B includes, as illustrated in FIG. 6,
a second bend 12Ba having a bent shape coupled to a second bottom surface 11Bb that is one surface formed on a circumference of a second housing 11B that is the housing 11 in the end battery cell 10B,
a second extension 12Bb extending from the second bend 12Ba toward the one side in the layered direction,
a third bend 12Bc that is coupled to one end of the second extension 12Bb and that has a shape bending toward the end battery cell 10B, and
a third extension 12Bd extending from the third bend 12Bc toward the other side in the layered direction.

In the end battery cell 10B according to the present embodiment, as illustrated in FIG. 4, after the sealing surface 13a is sealed and the seal 13 is formed, and then the grease 60 is applied onto the second bottom surface 11Bb of the second housing 11B, the second periphery 12B is bent at its base toward the one side in the layered direction and the second bend 12Ba is thus formed. Note that, in the end battery cell 10B, a part of the second extension 12Bb extending from the second bend 12Ba is further bent toward the second housing 11B, and the third bend 12Bc and the third extension 12Bd extending from the third bend 12Bc are formed.

The battery module 1 configured as described above includes the plurality of battery cells 10 each including
the layered body 10b layered with a positive electrode layer,
   a solid electrolyte layer or a separator, and a negative electrode layer, and
   the exterior body10a wrapping around the layered body 10b, in which
   the plurality of battery cells 10 are arranged in the layered direction of the layered bodies 10b, and,
   when any one of the battery cells 10 excluding the end battery cell 10B among the plurality of battery cells 10 is designated as the general battery cell 10A,
   the exterior body 10a of the general battery cell 10A includes the first housing 11A accommodating the layered body 10b, and the first periphery 12A formed around the entire circumference of the first housing 11A,
the first periphery 12A includes
   the first bend 12A a that is coupled to the first bottom surface 11Ab formed on the circumference of the first housing 11A and that has a shape bending toward the one side in the layered direction, and
   the first extension 12Ab extending from the first bend 12A a toward the one side in the layered direction, and
the first extension 12Ab includes
   the first region 12Ab1 extending from the first bend 12A a to the other end in the layered direction of the battery cell 10 next to the general battery cell 10A, and
   the second region 12Ab2 extending from the other end in the layered direction of the next battery cell 10 toward the one side in the layered direction.

Thereby, it is possible to reduce the amount to which the periphery 12 protrudes from the housing 11, and, by increasing the battery cells 10 or decreasing the battery module 1 in size accordingly, it is possible to increase the energy density of the battery module 1.

Furthermore, the battery module 1 according to the embodiment of the present invention further includes the thermal conductor 50 disposed at a position opposed to the first housing 11A to sandwich the first extension 12Ab of the first periphery 12A.

Conventionally, the periphery 12 protrudes from the circumference of the housing 11 toward the thermal conductive gel and is inserted into the thermal conductive gel. Therefore, it was necessary to thicken the thermal conductive gel in accordance with the extent of the protrusion. The periphery 12 in the battery module 1 according to the present embodiment, as illustrated in FIG. 4, is formed longer from the base to the tip, compared with the conventional ones. Therefore, it is possible to easily bend the periphery 12 at the base that serves as a pivot by applying a force to the tip. Therefore, it is possible to reduce the amount of protrusion into the thermal conductive gel through folding at the base, and it is possible to reduce the thickness of the thermal conductive gel.

Furthermore, conventionally, the battery cells 10 and the thermal conductive gel were in contact with each other, and, in order to allow the thermal conductive gel to respond to expansion and contraction of the battery cells 10, such a thicker thermal conductive gel has been used that has a higher stretch rate. However, in the battery module 1 described above, by disposing the periphery 12 that is bent between the housing and the thermal conductive gel, the battery cell 10 and the thermal conductive gel are not in contact with each other, making it possible to use a thinner thermal conductive gel that has a lower stretch rate. Therefore, the thickness of the thermal conductive gel is reduced, making it possible to increase the battery cells 10 or decrease the battery module 1 in size accordingly. Thereby, it is possible to provide a battery module with higher energy density.

Furthermore, the battery module 1 according to the embodiment of the present invention includes the water jacket 70 that is disposed at a position opposed to the first extension 12Ab so that the thermal conductor 50 is provided between the water jacket 70 and the first extension 12Ab, and that is able to adjust the temperature inside the battery module 1 via the thermal conductor 50.

Thereby, the battery cell 10 is able to further efficiently release heat to outside by the water jacket 70 via the thermal conductor 50 to suppress such an event that the temperature inside the battery cell 10 rises to lower its performance.

Furthermore, in the battery module 1 according to the embodiment of the present invention further includes the plurality of cushions 20 alternately arranged with the plurality of battery cells 10 in the layered direction, the two end plates 30 disposed to sandwich both end sides in the layered direction of the arrangement of the battery cells 10 and the cushions 20, and the two bind bars 40 disposed to sandwich the arrangement of the battery cells 10 and the cushions 20 in the upper-lower or lower-upper direction orthogonal or substantially orthogonal to the layered direction, the thermal conductor 50 includes a plurality of thermal conductive gels, and the water jacket 70 is disposed to be in contact with the thermal conductive gels to sandwich the thermal conductive gel of the thermal conductor 50, the bind bar 40, and the thermal conductive gel of the thermal conductor 50 in order between the water jacket 70 and the first extension 12Ab.

Thereby, the water jacket 70 is able to efficiently release heat to outside via the thermal conductor 50, and, for the battery cell 10, it is possible to suppress such an event that the temperature inside the battery cell 10 rises to lower its performance.

Furthermore, in the battery module 1 according to the embodiment of the present invention, when one of the battery cells 10 is the end battery cell 10B at the end in the arrangement of the plurality of battery cells 10 on one side in the layered direction, the thermal conductor 50 is not disposed on the one side in the layered direction of the end battery cell 10B in the layered direction.

Thereby, in an area on the one side in the layered direction of the end battery cell 10B, there is a location where the temperature is low in the battery module 1, and there is no possibility that the battery module 1 lowers its performance even without the thermal conductor 50, and it is possible to reduce the thermal conductor 50 in amount in the battery module 1, making it possible to achieve weight reductions and cost reductions.

Furthermore, in the battery module 1 according to the embodiment of the present invention, the grease 60 is provided between the first bottom surface 11Ab and the first periphery 12A in the first region 12Ab1 of the first extension 12Ab.

Thereby, it is possible to transmit heat from the battery cell 10 to the thermal conductor 50.

Furthermore, in the battery module 1 according to the embodiment of the present invention, when one of the battery cells 10 is the end battery cell 10B at the end in the arrangement of the plurality of battery cells 10,
the exterior body 10a of the end battery cell 10B includes
   the second housing 11B accommodating the layered body 10b, and
   the second periphery 12B formed around the entire
   circumference of the second housing 11B, and
the second periphery 12B includes
   the second bend 12Ba having a bent shape coupled to the circumference of the second housing 11B,
   the second extension 12Bb extending from the second bend 12Ba toward the one side in the layered direction,
   the third bend 12Bc that is coupled to one end of the second extension 12Bb and that has a shape bending toward the second housing 11B, and
   the third extension 12Bd extending from the third bend 12Bc toward the other side in the layered direction.

Thereby, by disposing the end battery cell 10B having the second periphery 12B that is bent, even in a narrow space at one end in the layered direction in the battery module 1, it is possible to reduce the amount of protrusion into the thermal conductive gel, making it possible to provide a battery module with higher energy density.

### Modification Examples

Note that the present invention is not limited to the embodiment described above. The present invention still includes amendments and modifications, for example, that fall within the scope of the present invention, as long as it is possible to achieve the object of the present invention. When the configuration of a battery module 1 according to a modification example is similar to the configuration of the embodiment described above, like reference names and numerals designate similar or identical components, and their detailed descriptions may be omitted.

### First Modification Example

In the battery module 1 according to the embodiment described above, the third bend 12Bc of the second periphery 12B is coupled to one end of the second extension 12Bb, bent toward the second housing 11B, and coupled to the third extension 12Bd extending toward the other side in the layered direction. However, the present invention is not limited to this configuration, the third bend 12Bc may be bent away from the second housing 11B.

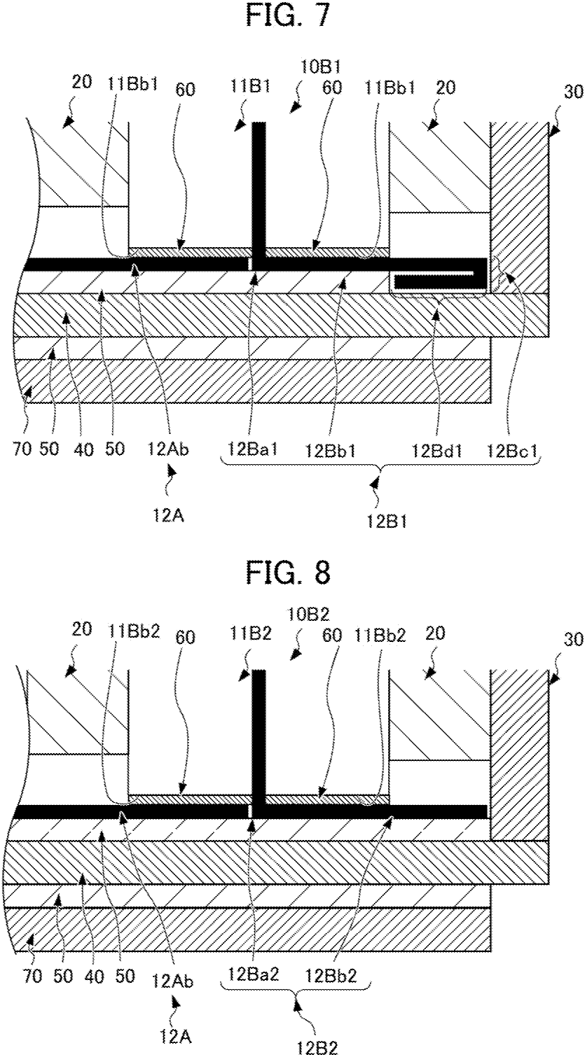

For example, in an end battery cell 10B1 in a battery module 1 according to a first modification example, a second periphery 12B1 may include, as illustrated in FIG. 7,
a second bend 12Ba1 having a bent shape coupled to a circumference of a second housing 11B1 that is a housing 11 in the end battery cell 10B1,
a second extension 12Bb1 extending from the second bend 12Ba1 toward the one side in the layered direction,
a third bend 12Bc1 that is coupled to one end of the second extension 12Bb1 and that has a shape bending away from the second housing 11B1, and
a third extension 12Bd1 extending from the third bend 12Bc1 toward the other side in the layered direction.

Thereby, by disposing the end battery cell 10B1 having the second periphery 12B1 that is bent, even at the end in the arrangement, where there is less space on the one side in the layered direction, it is possible to reduce the amount of protrusion into the thermal conductive gel, making it possible to provide a battery module with higher energy density. It should be noted that, in the case of the battery cell 10 being the end battery cell 10B on an end of the arrangement of a plurality of battery cells 10 at one side in the layered direction as shown in FIG. 7, the thermal conductor 50 may not be arranged more to one side in the layered direction than the end battery cell 10B in the layered direction.

### Second Modification Example

Furthermore, in the embodiment described above, the end battery cell 10B disposed at the end is formed by bending and folding the second periphery 12B twice at the parts, i.e., the second bend 12Ba and the third bend 12Bc, so that the end battery cell 10B could be disposed at the end where there is less space. However, the present invention is not limited to this configuration. For example, in a battery module 1 according to a second modification example, an end battery cell 10B2 has a shape, as illustrated in FIG. 8, where a part of the tip of the first extension 12Ab of the general battery cell 10A illustrated in FIG. 6 is cut out.

The end battery cell 10B2 includes
a second bend 12Ba2 that is coupled to a second bottom surface 11Bb2 formed on a circumference of a second housing 11B2 that is a housing 11 in the end battery cell 10B2 and that has a shape bending toward the one side in the layered direction, and
a second extension 12Bb2 extending from the second bend 12Ba2 toward the one side in the layered direction. The end battery cell 10B2 is formed, by forming it as described above, to make it possible to be disposed even at an end where there is less space by reducing the amount to which a second periphery 12B2 protrudes toward the one side in the layered direction.

Thereby, even at a position at the end, where there is less space on the one side in the layered direction, it is possible to dispose the end battery cell 10B2 having the second periphery 12B2 that is bent, making it possible to provide a battery module with higher energy density by reducing the amount of protrusion into the thermal conductive gel. Note that a part of the periphery 12 that has undergone cutting may be disposed in a space between the grease 60 and the thermal conductor 50 in the general battery cell 10A disposed at the other end in the layered direction, illustrated in FIG. 1.

### Third Modification Example

Furthermore, in the embodiment described above, the first periphery 12A includes
the first bend 12Aa having a bent shape coupled to the first bottom surface 11Ab that is the one surface formed on the circumference of the first housing 11A, and
the first extension 12Ab extending from the first bend 12Aa toward the one side in the layered direction, and, furthermore,
the first bend 12Aa and the first extension 12Ab are formed by bending parts that are not sealed on the first periphery 12A.

However, the present invention is not limited to this configuration.

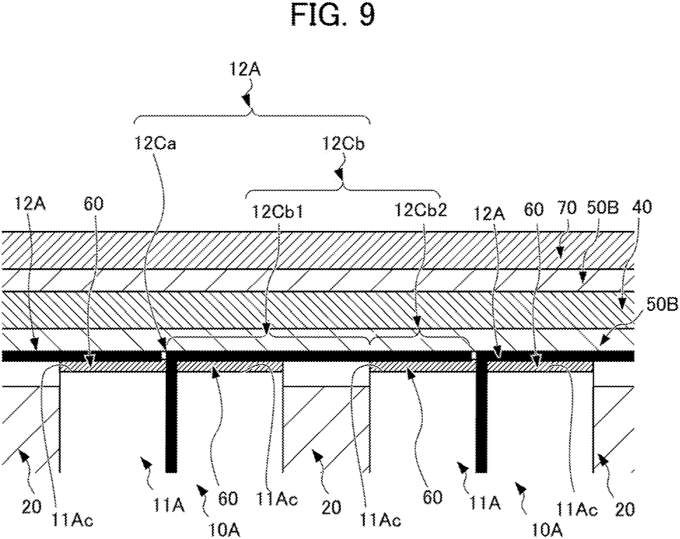

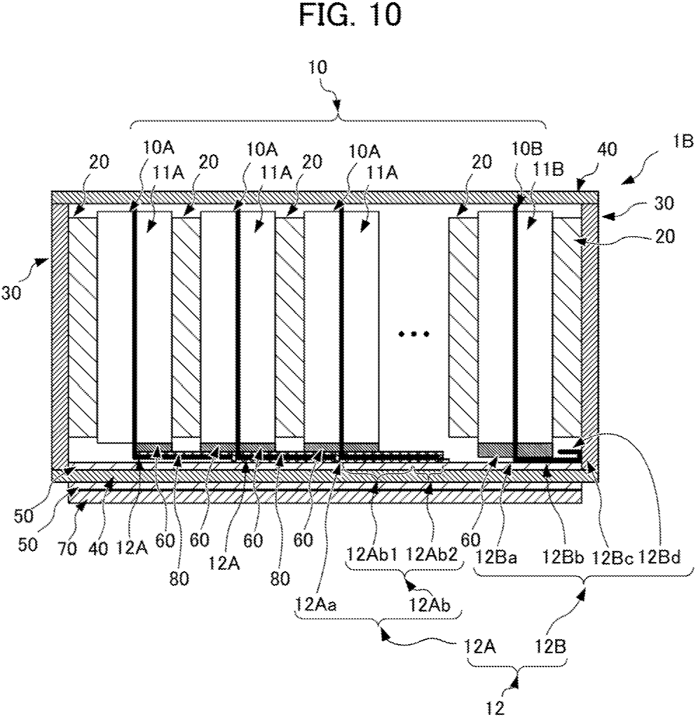

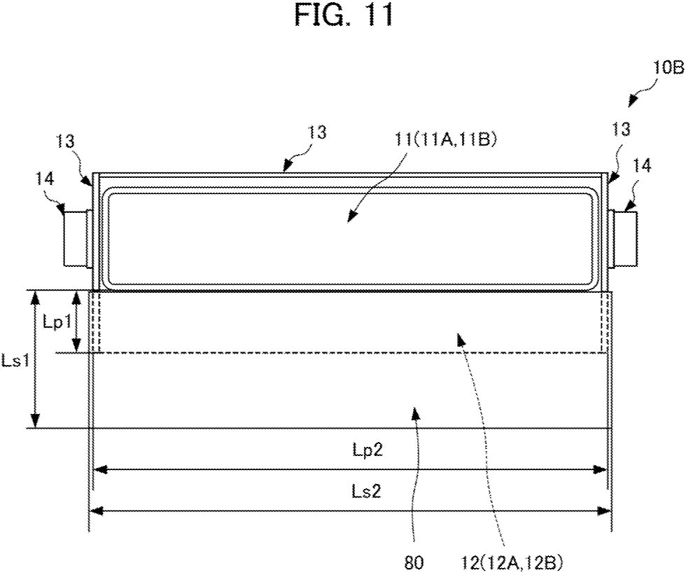

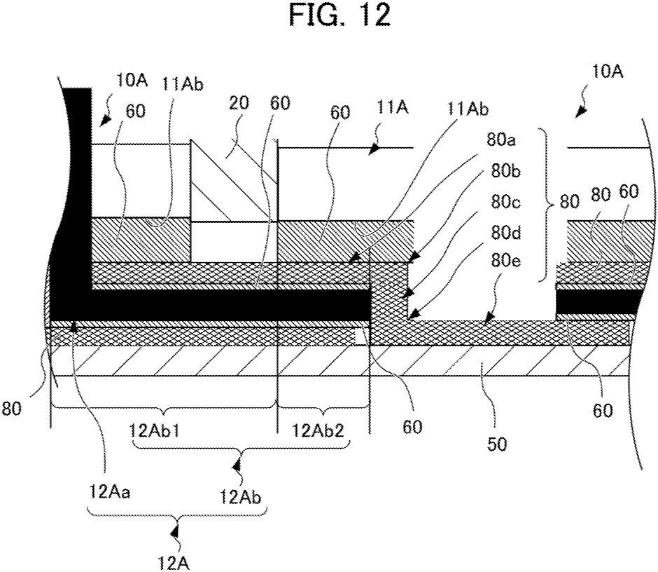

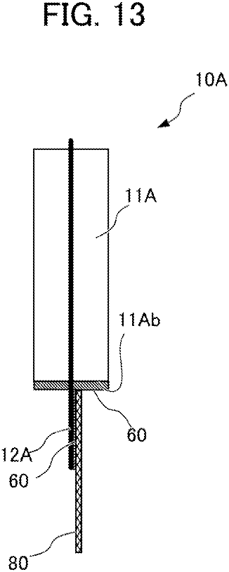

For example, in the battery module 1 according to the present modification example, as illustrated in FIG. 9, a thermal conductor 50B may be further provided adjacent to the first upper surface 11Ac, which is another surface than the first bottom surface 11Ab that the first housing 11A has, and is a surface provided on a top side in the upper-lower or lower-upper direction in FIG. 1, and
the first periphery 12A may have undergone sealing and may include
   an upper surface side first bend 12Ca having a bent shape coupled to the first upper surface 11Ac, and
   an upper surface side first extension 12Cb extending from the upper surface side first bend 12Ca toward the one side in the layered direction.

The upper surface side first extension 12Cb includes an upper surface side first region 12Cb1 extending from the upper surface side first bend 12Ca to the other end in the layered direction of the next battery cell 10, and an upper surface side second region 12Cb2 extending from the other end in the layered direction of the next battery cell 10 toward the one side in the layered direction. The upper surface side first region 12Cb1 is a part, on the upper surface side first extension 12Cb, for positioning between the general battery cell 10A serving as a first battery cell and the thermal conductor 50B provided adjacent to the first upper surface 11Ac of the battery cell 10. The upper surface side second region 12Cb2 is a part, on the upper surface side first extension 12Cb, for positioning between the next battery cell 10 serving as a second battery cell and the thermal conductor 50B.

Thereby, it is possible to further dispose the thermal conductor 50B on the upper surface side, to further efficiently release heat to outside, to prevent the temperature of the battery cells 10 from rising, and to suppress lowered performance.

### <Fourth Modification Example>

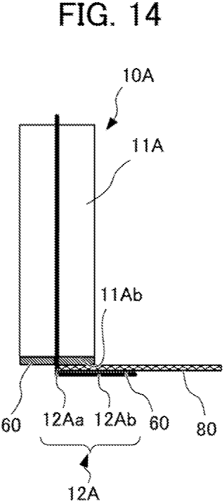

In addition, in the aforementioned embodiment, the general battery cell 10A is assembled to the battery module 1 in a form not accompanying other configurations at the surface of the first extension 12Ab; however, it is not limited to this configuration. For example, an insulation sheet 80 may be provided between the first bottom surface 11Ab as one surface formed at the circumference of the first housing 11A of any general battery cell 10A excluding the end battery cell 10B at an end side among the plurality of battery cells 10, and the first extension 12Ab, and between the first bottom surface 11Ab as one surface formed at the circumference of the first housing 11A of the general battery cell 10A adjacent to this general battery cell 10A and the first extension 12Ab, or between the second bottom surface 11Bb as one surface formed at the circumference of the second housing 11B of the end battery cell 10B adjacent to this general battery cell 10A and the second extension 12Bb. Hereinafter, a battery module according to the fourth modification example will be explained using FIG. 10. It should be noted that, in the following explanation, similar configurations to the battery module according to the aforementioned embodiment are assigned the same reference number and name, and detailed explanations thereof are omitted.

### <Battery Module>

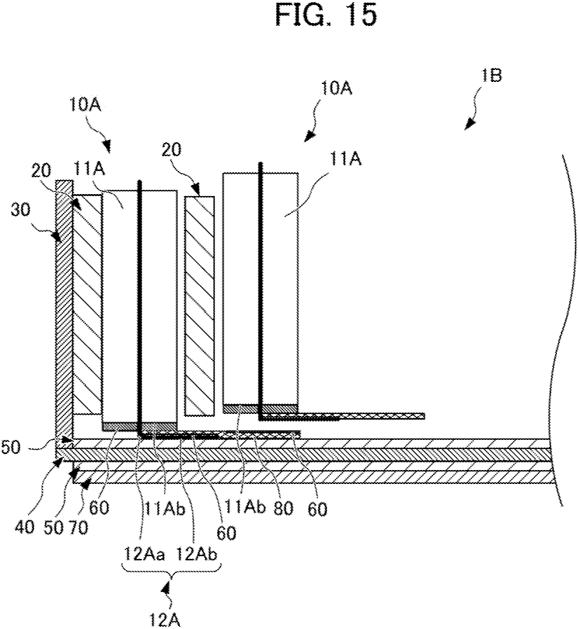

Hereinafter, an example of a battery module 1B according to the fourth modification example will be explained using FIGS. 10 to 12. FIG. 10 is a schematic cross-sectional view showing a cross section in the case of cutting the battery module 1B according to the fourth modification example in the layered direction. FIG. 11 is a schematic view showing an example of battery cells in a state in which the layered body of the fourth modification example of the present invention is arranged, and an insulation sheet is pasted to the exterior body after being folded back and sealed. FIG. 12 is a partially enlarged cross-sectional view enlarging a cross section of part of the first periphery of the general battery cell arranged at the intermediate part according to the fourth modification example of the present invention.

The battery module 1B according to the present modification example is equipped for supplying electric power to an electric vehicle such as EV, for example. The battery module 1B has a plurality of the battery cells 10, a plurality of cushions 20, two end plates 30, two bind bars 40, a thermal conductor 50, grease 60 serving as a highly viscous fluid applied at a plurality of locations, a water jacket 70 serving as a temperature adjuster, and an insulation sheet 80 arranged at a plurality of locations. It should be noted that the grease 60 is applied also to the insulation sheet 80 in addition to the applied locations of the aforementioned embodiment.

The insulation sheet 80 is a configuration for suppressing the periphery 12 of adjacent battery cells 10 contacting and becoming damaged, and short circuiting between battery cells 10 due to the occurred damage. The insulation sheet 80 is provided, as shown in FIGS. 10 and 11, between the first bottom surface 11Ab as one surface formed at the circumference of the first housing 11A of any general battery cell 10A excluding the end battery cell 10B at an end side among the plurality of battery cells 10, and the first extension 12Ab, and between the first bottom surface 11Ab as one surface formed at the first housing 11A of the general battery cell 10A adjacent to this general battery cell 10A, and the extension 12Ab of the first periphery.

In addition, the insulation sheet 80 may extend more to one side than a tip in the layered direction of the first extension 12Ab of any general battery cell 10A excluding the end battery cell 10B at an end side among the plurality of the battery cell 10, and may be arranged between the thermal conductor 50 and the first extension 12Ab adjacent to this general battery cell 10A.

In addition, the insulation sheet 80 may extend more to one side than the tip in the layered direction of the first extension 12Ab of any general battery cell 10A excluding the end battery cell 10B at an end side among the plurality of battery cells 10, and may be arranged between the thermal conductor 50 and the second extension 12Bb of the end battery cell 10B adjacent to this general battery cell 10A.

In addition, the insulation sheet 80 may be adhered to the first extension 12Ab. For example, the insulation sheet 80 may be adhered by the grease 60 by interposing the grease 60 as an adhesive between the first extension 12Ab. It should be noted that the adhesive for adhering the insulation sheet 80 to the first extension 12Ab is not limited to the grease 60.

In the present modification example, as shown in FIG. 12, the grease 60 is filled between the insulation sheet 80 and the first extension 12Ab of the general battery cell 10A. In other words, the insulation sheet 80 is pasted on the first extension 12Ab of the first periphery by interposing the grease 60.

The grease 60, more specifically, fills the space between the aforementioned first extension 12Ab of the first periphery 12A of the predetermined general battery cell 10A which is bent and the insulation sheet 80, and between the insulation sheet 80 and the first bottom surface 11Ab of the general battery cell 10A.

As described later, the grease 60 in this case is applied to one face among both faces of the first extension 12Ab of the first periphery 12A prior to bending of the first periphery 12A of the general battery cell 10A, and the insulation sheet 80 is pasted thereon.

In addition, in the case of the insulation sheet 80 being run between the first extension 12Ab of the general battery cell 10A adjacent to this general battery cell 10A and the thermal conductor 50, the grease 60 may be filled into the space between the first extension 12Ab and the insulation sheet 80. As described later, the grease 60 in this case, after bending of the first periphery 12A of the general battery cell 10A and before arrangement on the thermal conductor 50, is applied to the surface among both surfaces of the insulation sheet 80 on a side not pasted to the first extension 12Ab of the first periphery 12A, and the entire surface more to the outside than the end on an opposite side to the first bend 12Aa of the first extension 12Ab of the first periphery 12A.

The insulation sheet 80 preferably is a resin sheet following to some extent the expansion and contraction due to heat of the housing 11 of the battery cell 10, while having higher Young’s module so as not to transmit the influence of this expansion and contraction to the periphery 12, and is preferably PET (polyethylene terephthalate), for example. By establishing as such a material, the insulation sheet 80 tends to better follow the thermal expansion of the battery cell 10, and thus can suppress peeling from the periphery 12, damage of the sheet, etc.

In addition, the shape of the insulation sheet 80 is preferably substantially rectangular. The insulation sheet 80 according to the present modification example is a sheet of substantially rectangular shape, as shown in FIG. 11. However, the shape of the insulation sheet 80 is not limited thereto.

In the case of establishing a shorter side of the insulation sheet 80 as the short side, the length Ls1 of the short side is preferably longer than the length Lp1 in the extending direction of the periphery 12 prior to bending, as in FIG. 11. The length of the short side Ls1 of the insulation sheet 80 according to the present modification example is set to twice the length Lp1 in the extending direction of the periphery 12 prior to bending. By making the above such setting of the length Ls1 of the short side of the insulation sheet 80, the insulation sheet 80 pasted to the periphery 12 projects by the length Lp1-Ls1 (length of the periphery 12 in the present modification example) more than the edge of the periphery 12 in the extending direction of the periphery 12. This projecting amount is arranged between the thermal conductor 50 and the first extension 12Ab of the general battery cell 10A adjacent to this general battery cell 10A, or between the thermal conductor 50 and the second extension 12Bb of the end battery cell 10B adjacent to this general battery cell 10A.

In addition, in the case of establishing the longer side of the insulation sheet 80 as the long side, the length of the long side Ls2 is preferably longer than the length Lp2 in the width direction substantially orthogonal to the extending direction of the periphery 12 prior to bending, as in FIG. 11. The length LS2 of the long side of the insulation sheet 80 according to the present modification example is set to a length 1.01 times of the length Lp2 in the width direction of the periphery 12 prior to bending. By making the above such setting of the length of the long side of the insulation sheet 80, the insulation sheet 80 pasted to the periphery 12 can be arranged so as to conceal the sealant on both end sides of the periphery 12 in the width direction of the periphery 12, viewing in the depth direction of FIG. 11.

For this reason, the battery module 1B according to the present modification example can further suppress the periphery 12 of adjacent battery cells 10 from contacting and becoming damaged, and short circuiting between battery cells 10 due to the occurred damage. It should be noted that the setting of the length of the short side Ls1 of the insulation sheet 80 and the length of the long side Ls2 is not limited to this.

In addition, the sheet thickness of the insulation sheet 80 is preferably set as no more than 0.1 mm for a thermal resistance reduction.

The arrangement of insulation sheet 80 will be more specifically explained using FIG. 12. The insulation sheet 80 pasted to the first periphery 12A of the general battery cell 10A on the left side of two general battery cells 10A shown in FIG. 12 will be explained. As shown in FIG. 12, the insulation sheet 80 has the first sheet extension 80a, first sheet bend 80b, second sheet extension 80c, second sheet bend 80d and third sheet extension 80e.

The first sheet extension 80a of the insulation sheet 80 is arranged so as to extend from an end on the other side in the layered direction of the first extension 12Ab until the end on the one side, as shown in FIG. 12. In other words, the first sheet extension 80a of the insulation sheet 80 is arranged so as to extend from the end on the other side in the layered direction of the first extension 12Ab until an end on the other side, of a first region 12Ab1 and second region 12Ab2 of the first extension 12Ab.

At this time, the first sheet extension 80a of the insulation sheet 80 is arranged between the first extension 12Ab and the first bottom surface 11Ab. In more detail, the first sheet extension 80a of the insulation sheet 80 is arranged so as to be sandwiched by the first extension 12Ab and grease 60.

The first sheet bend 80b of the insulation sheet 80 is arranged so as to bend to the side of the thermal conductor 50, as shown in FIG. 12.

The second sheet extension 80c of the insulation sheet 80 is arranged so as to extend towards the thermal conductor 50, as shown in FIG. 12. At this time, the second sheet extension 80c of the insulation sheet 80 is arranged so as to cover the end face of the first extension 12Ab.

The second sheet bend 80d of the insulation sheet 80 is arranged so as to bend to one side in the layered direction, as shown in FIG. 12.

The third sheet extension 80e of the insulation sheet 80 is arranged so as to extend to one side in the layered direction, as shown in FIG. 12. At this time, the third sheet extension 80e of the insulation sheet 80 is arranged to extend so as to be sandwiched between the thermal conductor 50 and the first extension 12Ab of the general battery cell 10A on the right side adjacent to the general battery cell 10A on the left side.

Such a battery cell 10 is fit in the battery module 1B after bending of the periphery 12. The insulation sheet 80 projects from the edge of the periphery 12 after bending by the length of the periphery 12, and the portion projecting from the edge of the periphery 12 of the insulation sheet 80 is arranged on the thermal conductor 50. In this state, when installing yet another battery cell 10 to one side of the battery cell 10, this battery cell 10 can be arranged on the insulation sheet 80 of the above battery cell 10, and the thermal conductor 50 will not directly contact from the periphery 12, and thus this battery cell 10 can suppress damage from contact.

Next, the battery cell 10 will be explained using FIGS. 2 to 4. The battery cell 10 according to the present modification example is the same configuration except for the insulation sheet 80 pasted to the periphery 12 of the battery cell 10 according to the aforementioned embodiment; therefore, only explanation related to the insulation sheet 80 is made hereinafter.

As shown in the examples of FIGS. 2 to 4, the exterior body 10a contacts with the sealing surface 13a, which is at a symmetrical position relative to the intermediate line 12a1 of the folding part 12a, by the being folded at the folding part 12a, whereby the sealing surface 13a is sealed by being heated in a state contacting with the sealing surface 13a at the symmetrical position to form the seal 13 shown in FIG. 4. In addition, the sealing surface 13a constitutes the periphery 12 along with the folding part 12a, by being sealed with the sealing surface 13a which is at the symmetrical position. In addition, by the sealing surface 13a being sealed, the housing 11 can seal airtightly and house the layered body 10b from outside. The battery cell 10 is completed before the periphery 12 is bent after sealing.

Next, the processes until assembly of the general battery cell 10A among the battery cell 10 to the battery module 1B will be explained using FIGS. 11, and 13 to 15. FIG. 13 is a schematic diagram when viewing the battery cell in the fourth modification example of the present invention after pasting the insulation sheet to the periphery, from a lateral side. FIG. 14 is a schematic diagram when viewing the battery cell after bending the periphery of the battery cell in FIG. 13, from a lateral side. FIG. 15 is a schematic diagram showing an aspect of assembling the battery cell of FIG. 14 to the battery module.

Among both faces of portions having the folding part 12a of the first periphery 12A prior to bending of the general battery cell 10A, the grease 60 is applied to the entirety of the surface on one side. Next, as shown in FIGS. 11 and 13, the insulation sheet 80 is pasted to the entirety of the surface on which the grease 60 was applied among both faces of the first periphery 12A. It should be noted that grease 60 is filled into the space between the first periphery 12A and insulation sheet 80, and a gap or the like preferably does not exist.

The insulation sheet 80 according to the present modification example, as mentioned above pastes to the surface on one side of the first periphery 12A, so that the seal 13 on both ends sides in the width direction of the first periphery 12A viewing from a surface direction of the first periphery 12A is hidden by the insulation sheet 80, and the edge of the first housing 11A is not hidden by the insulation sheet 80, as shown in FIG. 11.

For example, viewing in the depth direction of FIG. 11, the insulation sheet 80 pastes to one surface of the first periphery 12A, while abutting one side of the long sides of the insulation sheet 80 against the vertical wall of the first housing 11A, while the seal 13 on both end sides in the width direction of the first periphery 12A is maintained to be hidden by the insulation sheet 80.

Next, the general battery cell 10A to which the insulation sheet 80 was pasted is bent to a side on which the first periphery 12A was pasted of the insulation sheet 80, as shown in FIG. 14. Next, the grease 60 is applied to the face on the side not pasted to the first extension 12Ab of the surface of the insulation sheet 80, and the entirety of a face more to the outside than the end on the opposite side to the first bend 12A a of the first extension 12Ab.

Next, as shown in FIG. 15, the general battery cell 10A is assembled to the battery module 1B in order from the left side viewed towards the drawing. By assembling the general battery cell 10A in such an order, the insulation sheet 80 can extend more to one side than the tip in the layered direction of the first extension 12Ab of any general battery cell 10A excluding the end battery cell 10B on the end side among the plurality of battery cells 10, and be arranged between the thermal conductor 50 and the first extension 12Ab of the general battery cell 10A adjacent to this general battery cell 10A. It should be noted that the insulation sheet 80 may extend more to one side than the tip in the layered direction of the first extension 12Ab of any general battery cell 10A excluding the end battery cell 10B at the end side among the plurality of battery cells 10, and be arranged between the thermal conductor 50 and the second extension 12Bb of the end battery cell 10B adjacent to this general battery cell 10A.

It should be noted that, upon producing the electronic cell according to the fourth modification example, it becomes hard to fold due to being bent in a state pasting the insulation sheet 80, and the thickness of a portion bending increasing by the thickness of the pasted insulation sheet 80. For this reason, it is preferable for the length Lp1 in the extending direction of the first periphery 12A to be longer to be easy to bend.

In the battery module 1B configured in the above way, the insulation sheet 80 is provided between the first extension 12Ab and the first bottom surface 11Ab formed at the circumference of the first housing 11A of any general battery cell 10A excluding the end battery cell 10B at the end side among the plurality of battery cells 10, and between the first extension 12Ab and first bottom surface 11Ab formed at the circumference of the first housing 11A of the general battery cell 10A adjacent to this general battery cell 10A, or between the second extension 12Bb and the second bottom surface 11Bb as one surface formed at the circumference of the second housing 11B of the end battery cell 10B adjacent to this general battery cell 10A.

It is thereby possible to further raise the energy density, while suppressing the periphery 12 of adjacent battery cells 10 from contacting and becoming damaged, and short circuiting between adjacent battery cells 10 due to the occurred damage.

In addition, the battery module 1B according to the present modification example includes the thermal conductor 50 arranged at a position opposing the first housing 11A, so as to sandwich the first extension 12Ab of the first periphery 12A, in which the insulation sheet 80 extends more to one side than the tip in the layered direction of the first extension 12Ab of any of the general battery cells 10A excluding the end battery cell 10B at the end side among the plurality of battery cells 10, and is arranged between the thermal conductor 50 and the first extension 12Ab of the general battery cell 10A adjacent to this general battery cell 10A, or between the thermal conductor 50 and the second extension 12Bb of the end battery cell 10B adjacent to this general battery cell 10A.

It is thereby possible to further raise the energy density, while suppressing the periphery 12 of the battery cell 10 and the thermal conductor 50 from contacting and becoming damaged, and short circuiting between adjacent battery cells 10 due to the occurred damage.

In addition, the insulation sheet 80 is adhered to the first extension 12Ab.

It is thereby possible to further raise the energy density, while suppressing the insulation sheet 80 from distancing from the first extension 12Ab, and more reliably suppressing the periphery 12 of the adjacent battery cells 10 and the thermal conductor 50 from contacting and becoming damaged, and short circuiting between adjacent battery cells 10 due to the occurred damage.

In addition, in the battery module 1B according to the present modification example, the grease 60 is filled between the insulation sheet 80 and first extension 12Ab.

It is thereby possible to further raise the energy density, while decreasing the interfacial thermal resistance between the first extension and insulation sheet 80, and while suppressing the periphery 12 of the adjacent battery cells 10 from contacting and becoming damaged, and short circuiting between adjacent battery cells 10 due to the occurred damage.

### Other Modification Examples

Furthermore, the exterior body 10a is formed by folding a single sheet member. However, the present invention is not limited to this configuration. For example, the battery cell 10 may be formed by forming, on each of two sheet members, one recess and a sealing flange surrounding the recess, by wrapping around a layered body by causing the recesses to face each other, and by sealing the sealing flanges on the four sides. In this case, a bend and an extension may be formed by bending any one of the sealing flanges on the four sides of the periphery 12 as described above.

What is claimed is:

1. A battery module comprising a plurality of battery cells each including
a layered body layered with a positive electrode layer, a solid electrolyte layer or a separator, and a negative electrode layer, and
an exterior body wrapping around the layered body, wherein
the plurality of battery cells are arranged in a layered direction of the layered bodies, and,
when any one of the battery cells excluding the battery cell on an end side among the plurality of battery cells is designated as a first battery cell,
the exterior body of the first battery cell includes
a first housing accommodating the layered body, and
a first periphery formed around an entire circumference of the first housing,
the first periphery includes
a first bend that is coupled to one surface formed on a circumference of the first housing and that has a shape bending toward one side in the layered direction, and
a first extension extending from the first bend toward the one side in the layered direction, and
the first extension includes
a first region extending from the first bend to another end in the layered direction of a second battery cell next to the first battery cell, and
a second region extending from the other end in the layered direction of the second battery cell toward the one side in the layered direction.

2. The battery module according to claim 1, further comprising a thermal conductor disposed at a position opposed to the first housing to sandwich the first extension of the first periphery between the thermal conductor and the first housing.

3. The battery module according to claim 2, further comprising a temperature adjuster that is disposed at a position opposed to the first extension so that the thermal conductor is provided between the temperature adjuster and the first extension and that is able to adjust a temperature inside the battery module via the thermal conductor.

4. The battery module according to claim 3, further comprising:
a plurality of cushions alternately arranged with the plurality of battery cells in the layered direction;
two end plates disposed to sandwich both end sides in the layered direction of the arrangement of the battery cells and the cushions; and
two bind bars disposed to sandwich the arrangement of the battery cells and the cushions in an upper-lower or lower-upper direction orthogonal or substantially orthogonal to the layered direction, wherein
the thermal conductor is a thermal conductive gel that is in contact with the first extension, and
the temperature adjuster is disposed to be in contact with the thermal conductive gels to sandwich the thermal conductive gel, the bind bars, and the thermal conductive gel in order between the temperature adjuster and the first extension.

5. The battery module according to claim 2, wherein, when the second battery cell is the battery cell at an end in an arrangement of the plurality of battery cells on one side in the layered direction, the thermal conductor is not disposed in an area on the one side in the layered direction of the second battery cell in the layered direction.

6. The battery module according to claim 1, wherein, in the first region of the first extension, a highly viscous fluid is provided between the one surface and the first periphery.

7. The battery module according to claim 1, wherein, when the second battery cell is the battery cell at the end in the arrangement of the plurality of battery cells,
the exterior body of the second battery cell includes
a second housing accommodating the layered body, and
a second periphery formed around an entire circumference of the second housing, and
the second periphery includes
a second bend having a bent shape coupled to the circumference of the second housing,
a second extension extending from the second bend toward the one side in the layered direction,
a third bend that is coupled to one end of the second extension and that has a shape bending toward the second housing, and
a third extension extending from the third bend toward the other side in the layered direction.

8. The battery module according to claim 5, wherein, when the second battery cell is the battery cell at the end in the arrangement of the plurality of battery cells,
the exterior body of the second battery cell includes
a second housing accommodating the layered body, and
a second periphery formed on a circumference of the second housing, and
the second periphery includes
a second bend having a bent shape coupled to the circumference of the second housing,
a second extension extending from the second bend toward the one side in the layered direction,
a third bend that is coupled to one end of the second extension and that has a shape bending away from the second housing, and
a third extension extending from the third bend toward the other side in the layered direction.

9. The battery module according to claim 1, wherein the first periphery includes
an upper surface side first bend having a bent shape and being coupled to another surface than the one surface of the first housing, and
an upper surface side first extension extending from the upper surface side first bend toward the one side in the layered direction.

10. The battery module according to claim 1, wherein an insulation sheet is provided between the first extension and the one surface formed at the circumference of the first housing of any of the battery cells excluding the battery cell at an end side among the plurality of battery cells, and between the first extension and the one surface formed at the circumference of the housing of the battery cell adjacent to this battery cell.

11. The battery module according to claim 10, further comprising a thermal conductor disposed at a position opposed to the first housing so as to sandwich the first extension of the first periphery,
wherein the insulation sheet extends more to the one side than a tip of the layered direction of the first extension of any of the battery cells excluding the battery cell at an end side among the plurality of the battery cells, and is disposed between the thermal conductor and the first extension of the battery cell adjacent to this battery cell.

12. The battery module according to claim 10, wherein the insulation sheet is adhered to the first extension.

13. The battery module according to claim 10, wherein grease is filled between the insulation sheet and the first extension.
